(19) United States
(12) Patent Application Publication
(10) Pub. No.: US 2016/0216856 A1
(43) Pub. Date: Jul. 28, 2016

(54) Method for Integrating Notifications from Handheld Computer with Windows Personal Computer

(71) Applicants: Gary Kung, Santa Ana, CA (US); Johnny Chen, Taipei City (TW)

(72) Inventors: Gary Kung, Santa Ana, CA (US); Johnny Chen, Taipei City (TW)

(73) Assignee: I/O INTERCONNECT, LTD., Santa Ana, CA (US)

(21) Appl. No.: 15/063,454

(22) Filed: Mar. 7, 2016

Related U.S. Application Data
(63) Continuation-in-part of application No. 14/607,046, filed on Jan. 27, 2015.

(51) Int. Cl. G06F 3/0482; G06F 3/0484; G09G 5/12; G06F 13/42

(52) U.S. Cl. CPC G06F 3/0482; G06F 13/4282; G06F 3/04842; G09G 5/12; G09G 2370/16

(57) ABSTRACT

A method for integrating notifications of a mobile device into an Action Center of a Windows personal computer is disclosed. The method includes the steps of: a) operatably connecting the handheld computer to the Windows personal computer; b) acquiring a list of active notifications; c) sending a notification to the Windows personal computer; and d) the Windows personal computer displaying the notification in an Action Center.

### CROSS-REFERENCE TO RELATED APPLICATIONS

This application is a continuation-in-part of U.S. patent application Ser. No. 14/607,046, filed Jan. 27, 2015, now pending.

### BACKGROUND OF THE INVENTION

1. Technical Field

The invention relates to combination of a personal computer and a handheld computer such as a smartphone or a tablet computer, particularly to integration of notifications between a handheld computer and a personal computer.

2. Related Art

Handheld computers, such as smartphones and tablets, have become essential for most people. Users of handheld computers have the need to connect their handheld computers to an external personal computer such as a desktop or a laptop computer which serves as a second computer. Some specific applications can open a subwindow within a screen picture on the display of the external personal computer to show a screen picture of the handheld computer on the personal computer when the handheld computer has been connected to the personal computer.

The Action Center is a notification center included with Windows Phone 8.1, Windows 10 and Windows 10 Mobile. It was first introduced with Windows Phone 8.1 in 2014, and was introduced to the desktop with the launch of Windows 10 in 2015. The Action Center retains a user's notification history, so if a user misses anything, he or she can open the center up and review them. Thus, the Action Center is a helpful tool for all users of personal computers. However, so far the Action Center cannot integrate notifications from a handheld computer which has connected to a personal computer. That is a fly in the ointment for users who always or usually connect their handheld computers to a personal computer because they cannot view any notifications from their handheld computers in the Action Center. However, there is no solution on the market yet.

### SUMMARY OF THE INVENTION

An object of the invention is to provide a method for integrating notifications from a handheld computer with a Windows personal computer, which can integrate notifications of a handheld computer into an Action Center of a personal computer to which the handheld computer is connected.

To accomplish the above said object, the method for integrating notifications from a handheld computer with a Windows personal computer of the invention includes the steps of:

a) operatably connecting the handheld computer to the Windows personal computer;

b) acquiring a list of active notifications;

c) sending a notification to the Windows personal computer; and

d) the Windows personal computer displaying the notification in an Action Center.

### BRIEF DESCRIPTION OF THE DRAWINGS

FIG. 1 is a schematic view of hardware arrangement of the invention;

FIG. 2 is a flowchart of the method of the invention; and

FIG. 3 is a schematic view showing the Action Center containing a notification from a handheld computer.

### DETAILED DESCRIPTION OF THE INVENTION

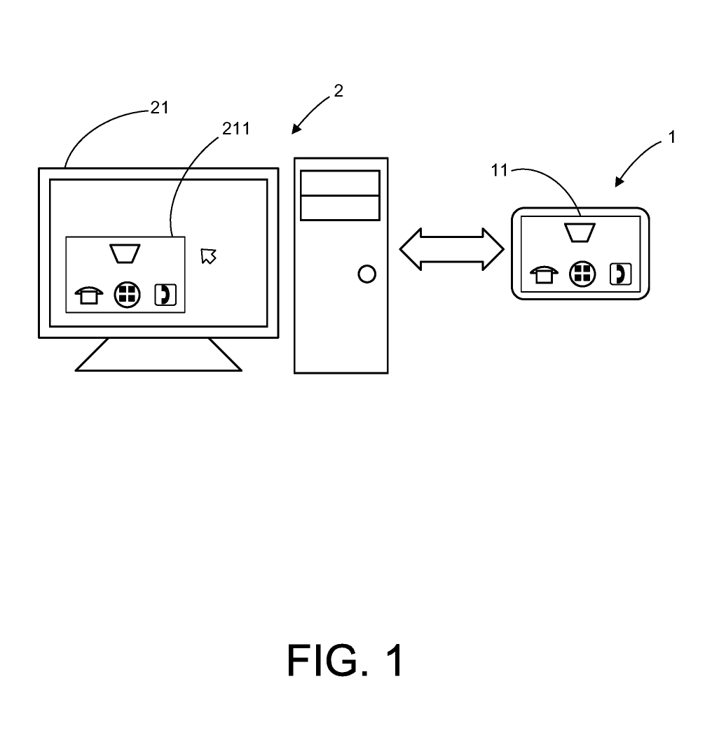

Please refer to FIG. 1. The invention provides a method for integrating notifications from a handheld computer 1 with a Windows personal computer 2. The handheld computer 1 may be a smartphone or a tablet computer based upon an Android operating system. The Windows personal computer 2 is based upon Windows 10 or any others which are provided with a function of Action Center like that in Windows 10. Of course, the handheld computer 1 and the Windows personal computer 2 must be provided with a first display 11 and a second display 21, respectively.

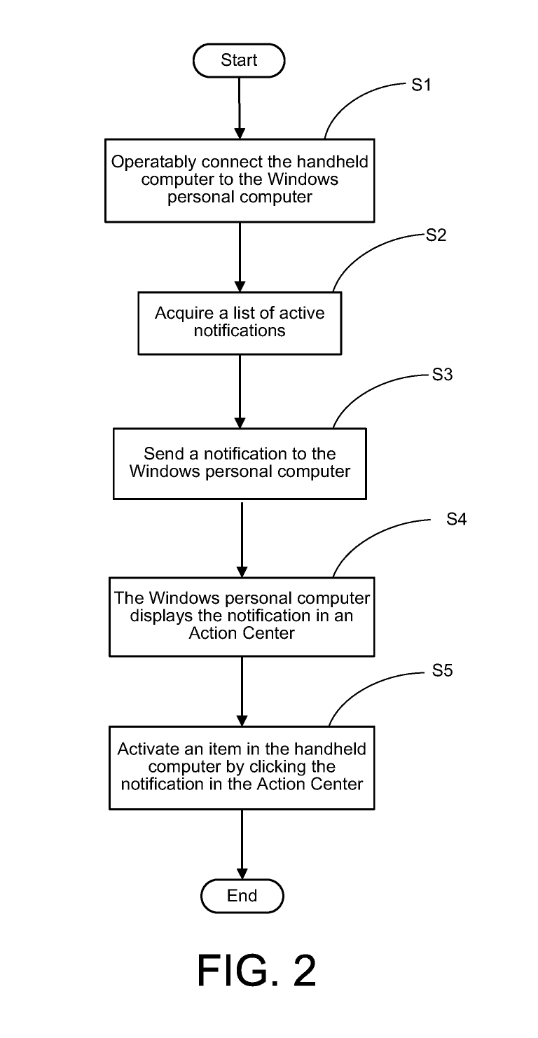

Please refer to FIG. 2, which shows a flowchart of the method of the invention. In step S1, the handheld computer 1 is operatably connected to the Windows personal computer 2. The connection between the handheld computer 1 and the Windows personal computer 2 may be wired or wireless. Such a wired connection may be implemented by a USB (universal serial bus) cable (not shown). In detail, an AOA (Android Open Accessory) protocol is performed between the handheld computer 1 and the Windows personal computer 2 through the USB cable. A wireless connection between the handheld computer 1 and the Windows personal computer 2 may be implemented by a BLUETOOTH or Wi-Fi communication protocol. A screen picture of the handheld computer 1 is projected on the second display 21 of the Windows personal computer 2 in a subwindow 211. The Windows personal computer 2 still keeps working independently. The screen picture of the handheld computer 1 is shown on the second display 21 just as a subwindow 211. Of course, all contents including items, pictures and their relative position of the subwindow 211 are the same as the handheld computer 1. Additionally, both the handheld computer 1 and the Windows personal computer 2 are separately installed with proprietary software applications.

In step S2, the software application in the handheld computer 1 acquires a list of active notifications of the handheld computer 1. The active notifications include incoming phone calls, incoming messages, reminders, warnings, etc.

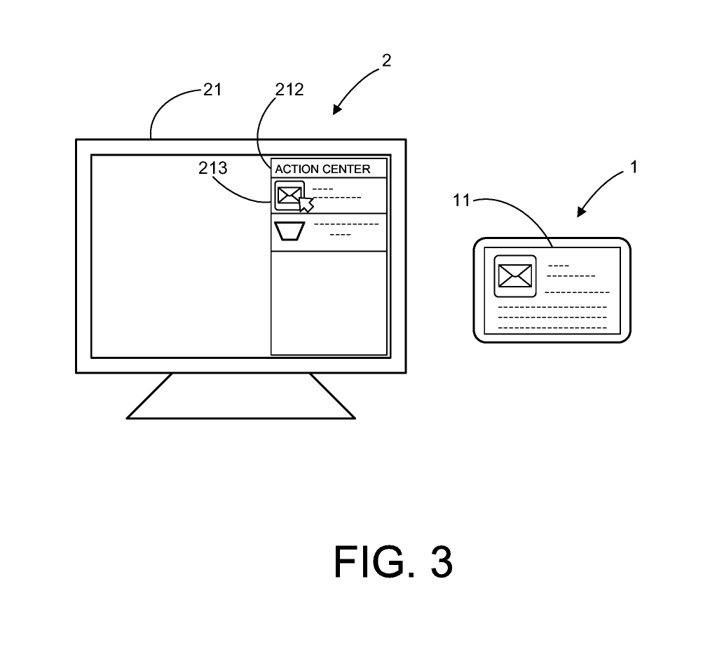

In step S3, the software application in the handheld computer 1 sends a notification to the Windows personal computer 2. In step S4, the Windows personal computer displays the notification 213 in an Action Center 212 as shown in FIG. 3.

Finally, in step S5, the Windows personal computer 2 pushes the handheld computer 1 to activate an item in the handheld computer 1 when the notification 213 in the Action Center 212 is clicked, wherein the notification 213 corresponds to the item. In other words, the item is completely expressed on the handheld computer 1.

In sum, by the method of the invention, all notifications of the handheld computer 1 can be displayed in the Action Center of the Windows personal computer 2. This will be very helpful for those users who connect their handheld computers to a Windows personal computer.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for integrating notifications from a handheld computer with a Windows personal computer, comprising the steps of:
a) operatably connecting the handheld computer to the Windows personal computer;
b) acquiring a list of active notifications;
c) sending a notification to the Windows personal computer; and
d) the Windows personal computer displaying the notification in an Action Center.

2. The method of claim 1, further comprising a step of e) after the step d): activating an item in the handheld computer by clicking the notification in the Action Center, wherein the notification corresponds to the item.

3. The method of claim 1, wherein the handheld computer is a smartphone or a tablet computer.

4. The method of claim 1, wherein a connection between the handheld computer and the personal computer is a wired link.

5. The method of claim 3, wherein the wired link is a USB (universal serial bus) cable.

6. The method of claim 5, wherein an AOA (Android Open Accessory) protocol is performed between the handheld computer and the Windows personal computer through the USB cable.

7. The method of claim 1, wherein a connection between the handheld computer and the personal computer is a wireless link.

8. The method of claim 6, wherein the wireless connection is a BLUETOOTH or Wi-Fi communication protocol.
